(19) United States
(12) Patent Application Publication
(10) Pub. No.: US 2021/0031725 A1
(43) Pub. Date: Feb. 4, 2021

(54) VEHICLE RAIN SENSOR, AND WIPER SYSTEM AND WIPER CONTROL METHOD USING THE SAME

(71) Applicants: HYUNDAI MOTOR COMPANY, Seoul (KR); KIA MOTORS CORPORATION, Seoul (KR)

(72) Inventor: Il Seon YOO, Hwaseongsi (KR)

(21) Appl. No.: 16/742,613

(22) Filed: Jan. 14, 2020

(30) Foreign Application Priority Data
Aug. 1, 2019 (KR) 10-2019-0093675

(51) Int. Cl. B60S 1/08; G01N 27/22

(52) U.S. Cl. CPC B60S 1/0825; B60S 1/0881; G01N 27/223

(57) ABSTRACT

A rain sensor includes: a substrate, a first sensor that is disposed on a first surface of the substrate and that senses a sound signal; a second sensor disposed on a second surface of the substrate and attached to windshield glass of the vehicle to sense a capacitance change; and a processor that determines precipitation, based on at least one of the sound signal or the capacitance change.

### CROSS-REFERENCE TO RELATED APPLICATION

This application claims the benefit of priority to Korean Patent Application No. 10-2019-0093675, filed in the Korean Intellectual Property Office on Aug. 1, 2019, the entire contents of which are incorporated herein by reference.

### TECHNICAL FIELD

The present disclosure relates to a vehicle rain sensor, and a wiper system and a wiper control method using the same.

### BACKGROUND

In general, when raindrops are brought into contact with the windshield of a vehicle, a rain sensor mounted on the vehicle detects the raindrops and measures the amount thereof. Examples of the rain sensor include a light-based rain sensor, a capacitance-based rain sensor, a sound-based rain sensor, a camera-based rain sensor, and the like.

The light-based rain sensor measures the amount of rainwater by measuring, through an infrared sensor, light signals reflected by raindrops. The light-based rain sensor may incorrectly determine a refraction change of light by an object other than raindrops as raindrops. The light-based rain sensor is sensitive to external light and therefore may malfunction, and the sensing area is small.

The capacitance-based rain sensor senses the amount of rainwater on the windshield glass by measuring a change in capacitance and/or resistance that is generated when raindrops are present between electrode patterns. The capacitance-based rain sensor is embedded in a multi-layer substrate. Due to an electrical wiring problem, the capacitance-based rain sensor is difficult to manufacture and is somewhat expensive.

The sound-based rain sensor measures the amount of rainwater by sensing, through a microphone, a sound pressure signal generated when raindrops are brought into contact with the windshield glass. The sound-based rain sensor requires a filter for selection of a specific frequency for removing an in-vehicle noise signal.

The camera-based rain sensor measures the amount of rainwater by analyzing a frequency pattern caused by voltage emission when raindrops are present on pixels in a Complementary Metal Oxide Semi-conductor (COMS) pixel sensor. The camera-based rain sensor has problems in that the measurement sensitivity to distinguish between rain drops fallen previously and rain drops fallen later is low, an optical sensor has a partial sensing area, and the camera-based rain sensor fails to distinguish between rain drops and objects such as dust or a leaf.

### SUMMARY

The present disclosure has been made to solve the above-mentioned problems occurring in the prior art while advantages achieved by the prior art are maintained intact.

An aspect of the present disclosure provides a rain sensor for a vehicle, and a wiper system and a wiper control method using the rain sensor, in which the rain sensor includes a microphone and a capacitive sensor integrated into a single module and is directly attached to the windshield glass of a vehicle to improve measurement sensitivity.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a rain sensor for a vehicle includes: a substrate; a first sensor that is disposed on a first surface of the substrate and that senses a sound signal; a second sensor disposed on a second surface of the substrate and attached to windshield glass of the vehicle to sense a capacitance change; and a processor that determines precipitation, based on at least one of the sound signal or the capacitance change.

The first sensor may include a Micro Electro-Mechanical Systems (MEMS) microphone.

The second sensor may be a capacitive sensor and may include a first capacitor and a second capacitor.

The first capacitor may include a pair of transparent electrodes spaced apart from each other by a first gap, and the second capacitor may include a pair of transparent electrodes spaced apart from each other by a second gap different from the first gap.

The first capacitor may detect a raindrop of a first size or more, and the second capacitor may detect a raindrop of a second size or less.

The first capacitor and the second capacitor may detect a raindrop of more than the first size and less than the second size together.

A thermal curable polymer adhesive may be used to attach the second surface of the substrate to the windshield glass of the vehicle.

The processor may determine whether the sound signal corresponds to a sound of rain, by analyzing strength and frequency characteristics of the sound signal.

The processor may determine a rainfall step by estimating a size, an amount, and a speed of a raindrop by analyzing the strength and the frequency characteristics of the sound signal.

The processor may determine a rainfall step by estimating a size, an amount, and a speed of a raindrop by analyzing the capacitance change.

The processor may transmit a rainfall step determination result to a wiper controller to control a movement of a wiper.

A wiper system may include the rain sensor and a wiper controller that controls a movement of a wiper, based on rainfall information measured by the rain sensor.

A method for controlling a wiper using the rain sensor includes: detecting at least one of a sound signal through the first sensor or the capacitance change through the second sensor; determining, by the rain sensor, a rainfall step based on at least one of the sound signal or the detected capacitance change; and controlling, by a wiper controller, a movement of the wiper according to the rainfall step.

The detecting at least one of the sound signal or the change in capacitance may include: detecting, by the rain sensor, the sound signal through the first sensor, determining, by the rain sensor, whether the sound signal corresponds to a sound of rain, by analyzing strength and frequency characteristics of the sound signal; and detecting, by the rain sensor, the capacitance change through the second sensor when the sound signal does not correspond to the sound of rain.

The determining a rainfall step may include determining the rainfall step by estimating a size, an amount, and a speed of a raindrop by analyzing the strength and the frequency characteristics of the sound signal when the sound signal corresponds to the sound of rain.

The determining a rainfall step may include determining whether the capacitance is increased and determining the rainfall step by estimating a size, an amount, and a speed of a raindrop by analyzing the capacitance change when the capacitance is increased.

The determining a rainfall step may further include standing by for a preset period of time when the capacitance is not increased, after the determining of whether the capacitance is increased.

The controlling a movement of the wiper may include adjusting, by the wiper controller, at least one of an operating speed or an operating interval of the wiper.

The wiper controller may operate the wiper to remove foreign matter when there is no change in capacitance measured by the second sensor in the rain sensor.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram of a wiper system according to an exemplary embodiment of the present disclosure;

FIG. 2A is a schematic view of a vehicle rain sensor according to an exemplary embodiment of the present disclosure;

FIG. 2B illustrates an electrode pattern structure of a second sensor according to an exemplary embodiment of the present disclosure;

FIG. 3 is a schematic sectional view of the vehicle rain sensor according to an exemplary embodiment of the present disclosure;

FIG. 4 is a graph of capacitance versus raindrop size for capacitors according to an exemplary embodiment of the present disclosure; and

FIG. 5 is a flowchart illustrating a wiper control method using the vehicle rain sensor according to an exemplary embodiment of the present disclosure.

### DETAILED DESCRIPTION

Hereinafter, exemplary embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

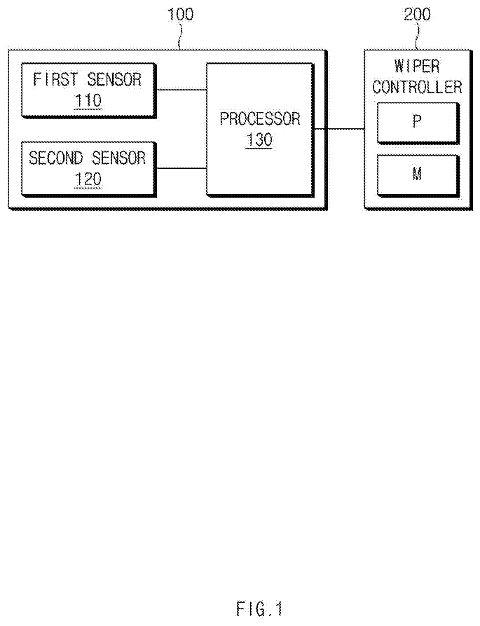

FIG. 1 is a block diagram of a wiper system according to an exemplary embodiment of the present disclosure.

Referring to FIG. 1, the wiper system includes a rain sensor 100 and a wiper controller 200 that are connected via an in-vehicle network (IVN). The IVN may be implemented with a Controller Area Network (CAN), a Media Oriented Systems Transport (MOST) network, a Local Interconnect Network (LIN), or an X-by-Wire (Flexray).

The rain sensor 100 is installed on a windshield glass of a vehicle and senses rainwater. The rain sensor 100 measures the size (e.g., surface area in contact with the windshield, etc.), amount (e.g., volume, etc.), and speed of raindrops that fall on a detecting area. The detecting area refers to an area where the rain sensor 100 is attached (stuck) to the windshield glass. The rain sensor 100 includes a first sensor 110, a second sensor 120, and a processor 130.

The first sensor 110 senses a sound signal generated when raindrops make contact with the windshield glass. The first sensor 110 may be implemented with a Micro Electro-Mechanical Systems (MEMS) microphone.

The second sensor 120 senses a capacitance change caused by raindrops that make contact with the detecting area of the windshield glass. In other words, the second sensor 120 measures capacitance caused by raindrops and outputs the measured capacitance to the processor 130.

The processor 130 receives sensing signals output from the first sensor 110 and the second sensor 120 and performs signal processing on the received sensing signals. The processor 130 may be implemented with at least one of an Application Specific Integrated Circuit (ASIC), a Digital Signal Processor (DSP), Programmable Logic Devices (PLDs), Field Programmable Gate Arrays (FPGAs), a Central Processing Unit (CPU), microcontrollers, and microprocessors. The processor 130 may include a memory (not illustrated). The memory (not illustrated) may store a program for an operation of the processor 130 and may store a table in which rainfall steps depending on the size, amount, and speed of raindrops are defined. The memory (not illustrated) may be implemented with at least one of storage media such a flash memory, a Random Access Memory (RAM), a Static Random Access Memory (SRAM), a Read Only Memory (ROM), a Programmable Read Only Memory (PROM), an Electrically Erasable and Programmable ROM (EEPROM), an Erasable and Programmable ROM (EPROM), a register, and the like.

When the ignition of the vehicle is turned on, the processor 130 starts to operate, depending on whether auto wiping activation is set or not. In the case where the auto wiping activation function is set, the processor 130 is automatically activated when the ignition of the vehicle is turned on.

The processor 130 analyzes a sound signal (a sound source) sensed by the first sensor 110 and determines whether the sound signal corresponds to the sound of rain. When it is determined that the sound signal output from the first sensor 110 corresponds to the sound of rain, the processor 130 may estimate (measure) the amount and speed of raindrops in view of strength and frequency characteristics of the sound signal. Furthermore, the processor 130 may estimate the size, amount, and speed of raindrops, based on a capacitance change sensed by the second sensor 120. The processor 130 measures the size, amount, and speed of raindrops through the first sensor 110 and/or the second sensor 120. The processor 130 determines a rainfall step, based on the measured size, amount, and speed of the raindrops. The processor 130 transmits a rainfall step determination result to the wiper controller 200.

The wiper controller 200 controls a movement of a wiper, based on the rainfall step determined by the rain sensor 100. The wiper controller 200 may include a processor P and a memory M. The memory M may store software programmed to cause the processor P to perform a predetermined operation. The memory M may store a lookup table in which wiper controls for respective rainfall steps are defined. The memory M may be implemented with at least one storage medium (recording medium) among storage media such a flash memory, a hard disk, a Secure Digital (SD) card, a Random Access Memory (RAM), a Static Random Access Memory (SRAM), a Read Only Memory (ROM), a Programmable Read Only Memory (PROM), an Electrically Erasable and Programmable ROM (EEPROM), an Erasable and Programmable ROM (EPROM), a register, a removable disk, and the like. The processor P controls an overall operation of the wiper controller 200. The processor P may be implemented with at least one of an Application Specific Integrated Circuit (ASIC), a Digital Signal Processor (DSP), Programmable Logic Devices (PLDs), Field Programmable Gate Arrays (FPGAs), a Central Processing Unit (CPU), microcontrollers, and microprocessors.

The wiper controller 200 adjusts the operating speed and the operating interval of the wiper in a stepwise manner according to the rainfall step determined by the rain sensor 100. That is, the wiper controller 200 may adjust a movement of the wiper by controlling a wiper motor that supplies power required to operate the wiper. When no raindrop is detected by the rain sensor 100, the wiper controller 200 stops operating the wiper.

In the case where the capacitance measured by the second sensor 120 does not change for preset reference time, the wiper controller 200 determines that foreign matter such as dust is present on the windshield glass. The reference time is set by a system designer in advance. When it is determined that foreign matter is present on the windshield glass, the wiper controller 200 removes the foreign matter by operating the wiper once.

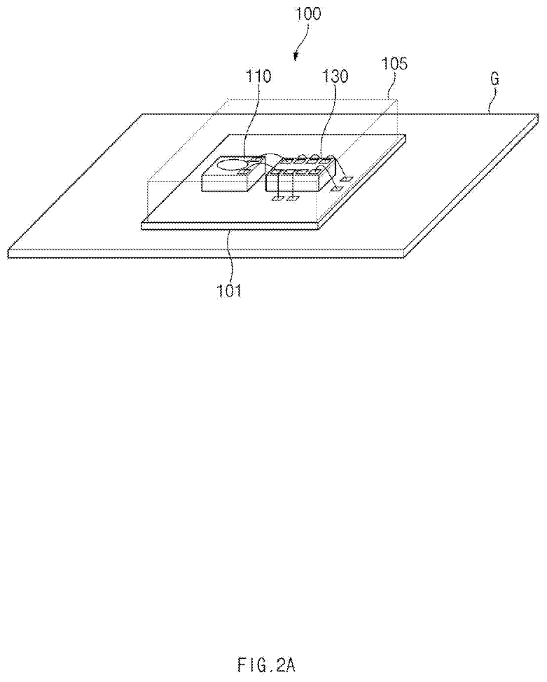

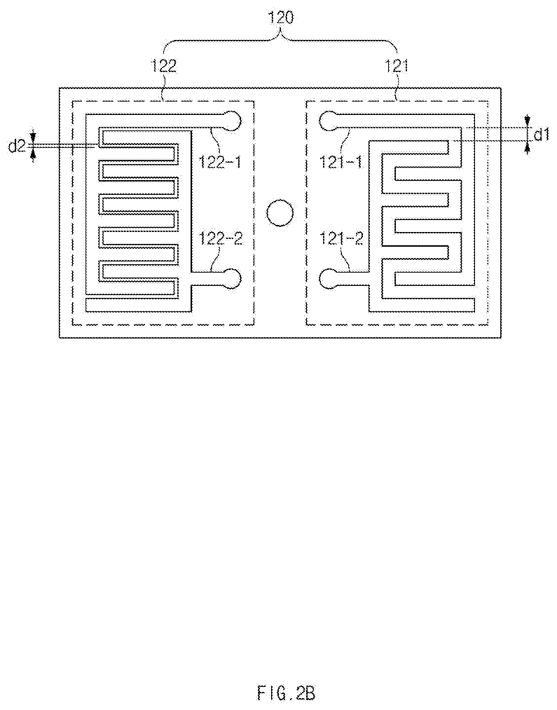

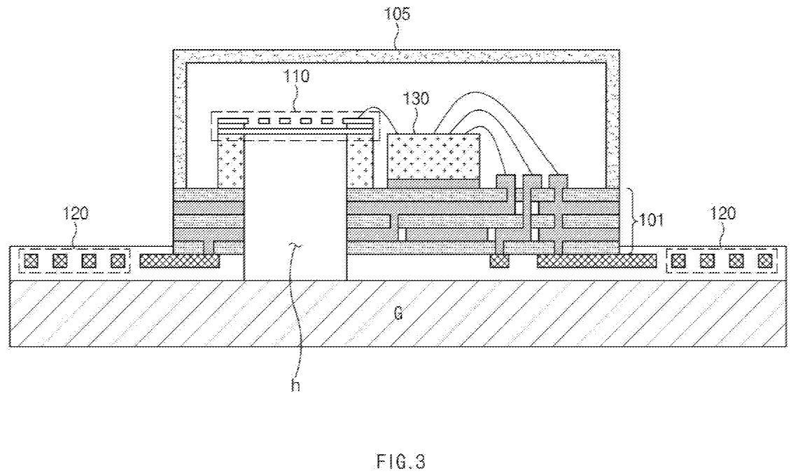

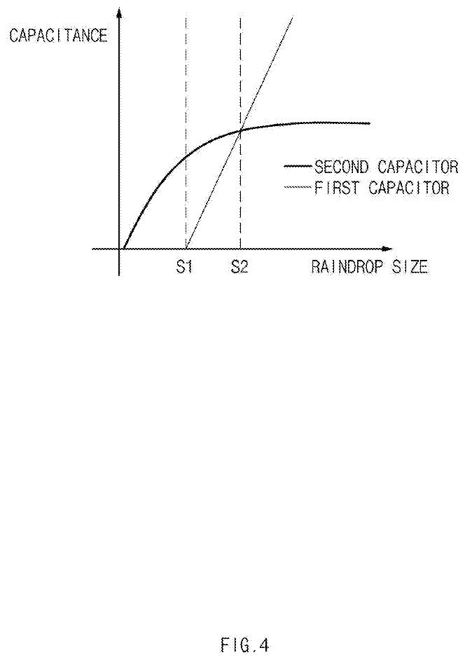

FIG. 2A is a schematic view of the vehicle rain sensor according to an exemplary embodiment of the present disclosure, and FIG. 2B illustrates an electrode pattern structure of the second sensor according to an exemplary embodiment of the present disclosure. FIG. 3 is a schematic sectional view of the vehicle rain sensor according to an exemplary embodiment of the present disclosure. FIG. 4 is a graph of capacitance versus raindrop size for capacitors according to an exemplary embodiment of the present disclosure.

Referring to FIGS. 2A, 2B, 3, and 4, the first sensor 110 and the second sensor 120, which constitute the rain sensor 100, are mounted on a single substrate 101. The substrate 101 is implemented with a laminated Printed Circuit Board (PCB). Each layer of the substrate 101 is formed of a metal layer capable of shielding electro-magnetic noise and is connected with another layer through a via hole electrode.

The first sensor 110 and the processor 130 are disposed on a first surface (an upper surface) of the substrate 101. As illustrated in FIG. 3, the first sensor 110 is mounted above a sound hole H formed in the substrate 101. A metal cap 105 for protecting the first sensor 110 and the processor 130 is disposed over the first sensor 110 and the processor 130.

As illustrated in FIG. 2B, the second sensor 120 is disposed on a second surface (a rear surface) of the substrate 101. The second sensor 120 includes a first capacitor 121 and a second capacitor 122. The first capacitor 121 includes a pair of first transparent electrodes 121-1 and 121-2 spaced apart from each other by a first gap d1. The second capacitor 122 includes a pair of second transparent electrodes 122-1 and 122-2 spaced apart from each other by a second gap d2. The first gap d1 is larger than the second gap d2. Referring to FIG. 4, the first capacitor 121 may detect raindrops of a first size S1 (e.g., surface area surface area in contact with the windshield) or more, and the second capacitor 122 may detect raindrops of a second size S2 (e.g., surface area surface area in contact with the windshield) or less. Furthermore, the first capacitor 121 and the second capacitor 122 may detect raindrops of more than the first size and less than the second size together.

The rain sensor 100 is directly attached to the windshield glass G of the vehicle. A thermal curable polymer adhesive, for example, a phenolic resin or a Nitrile-Butadiene Rubber (NBR) based adhesive film may be used to attach the rain sensor 100 to the windshield glass G of the vehicle.

As described above, the size of the rain sensor package may be reduced by integrating the two types of sensors, that is, the first sensor 110 and the second sensor 120 into a single module, and the measurement sensitivity of the second sensor 120 formed on the rear surface of the rain sensor package may be maximized by directly attaching the rain sensor package to the windshield glass G of the vehicle.

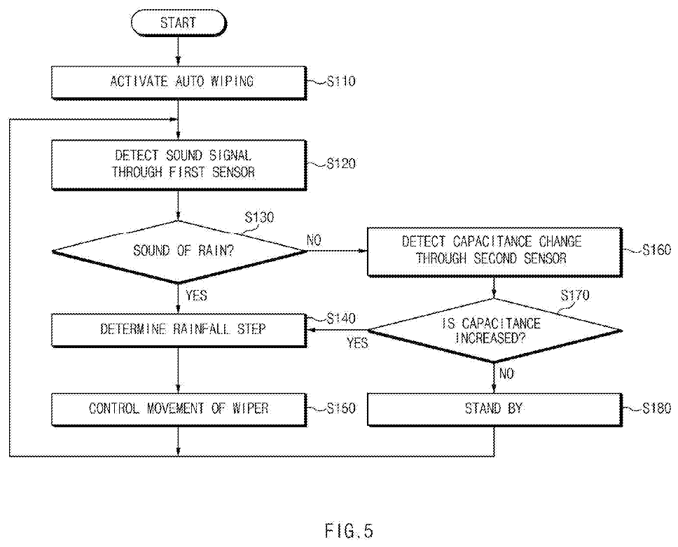

FIG. 5 is a flowchart illustrating a wiper control method using the vehicle rain sensor according to an exemplary embodiment of the present disclosure.

Referring to FIG. 5, the processor 130 of the rain sensor 100 activates an auto wiping function (S110). When the ignition of the vehicle is turned on, the processor 130 determines whether auto wiping activation is set or not, and the processor 130 starts to operate the rain sensor 100 when it is determined that the auto wiping activation is set.

The processor 130 detects a sound signal through the first sensor 110 (S120). The first sensor 110 senses a sound (a sound source) that is generated when raindrops apply impact to the windshield glass G of the vehicle.

The processor 130 determines whether the detected sound signal corresponds to the sound of rain (S130). The processor 130 determines whether the detected sound source corresponds to the sound of rain, by analyzing strength and frequency characteristics of the sound source (that is, the sound signal) detected by the first sensor 110.

When it is determined that the detected sound signal corresponds to the sound of rain, the processor 130 determines a rainfall step by analyzing the sound signal (S140). The processor 130 generates rainfall information by analyzing the strength and the frequency characteristics of the sound source, that is, the sound of rain and determines a rainfall step, based on the generated rainfall information. The rainfall information includes the size, amount, and speed of raindrops.

The wiper controller 200 controls a movement of the wiper according to the rainfall step that is provided from the processor 130 of the rain sensor 100 (S150). The wiper controller 200 adjusts the operating speed and the operating interval of the wiper according to the rainfall step determined by the rain sensor 100.

When it is determined in S130 that the detected sound signal does not correspond to the sound of rain, the processor 130 detects a change in capacitance through the second sensor 120 (S160). The second sensor 120 measures the capacitance of the first capacitor 121 and/or the second capacitor 122 that changes due to raindrops between the transparent electrodes of the first capacitor 121 and/or the second capacitor 122.

The processor 130 determines whether the capacitance sensed by the second sensor 120 is increased (S170). The processor 130 determines whether the capacitance is increased, by analyzing a change in the capacitance measured by the second sensor 120.

When it is determined that the capacitance is increased, the processor 130 determines a rainfall step by analyzing the capacitance change (S140). In the case where the capacitance of the first capacitor 121 is increased, the processor 130 determines that raindrops of the first size S1 or more fall, and in the case where the capacitance of the second capacitor 122 is increased, the processor 130 determines that raindrops of the second size S2 or less, that is, drizzle falls. That is, the processor 130 may determine the size of raindrops by analyzing the capacitance change. Furthermore, the processor 130 may determine the amount and speed of raindrops, based on the capacitance change. The processor 130 determines a rainfall step in view of the size, amount, and speed of raindrops and transmits a rainfall step determination result to the wiper controller 200. The wiper controller 200 controls a movement of the wiper, that is, the operating speed and the operating interval of the wiper, based on the determined rainfall step (S150).

The processor 130 stands by for a predetermined period of time (S180), when it is determined in S160 that the capacitance measured by the second sensor 120 is not increased. After the predetermined period of time elapses, the processor 130 returns to S120 and detects rainwater again.

According to the present disclosure, by applying the capacitive sensor having various forms of patterns, it is possible to improve sensing ability and thus detect raindrops of a drizzle level.

Furthermore, according to the present disclosure, the wiper is actively controlled by changing, through the microphone, visualized raindrops into an impact sound applied to the windshield glass of the vehicle. Thus, it is possible to closely approach a level determined by a driver.

In addition, according to the present disclosure, a capacitance change does not occur at the same time that it is recognized by the microphone that it does not rain consistently. Thus, it is possible to prevent a malfunction.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims. Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. A rain sensor for a vehicle, the rain sensor comprising:
a substrate;
a first sensor disposed on a first surface of the substrate and configured to sense a sound signal;
a second sensor disposed on a second surface of the substrate and attached to windshield glass of the vehicle to sense a capacitance change; and
a processor configured to determine precipitation, based on at least one of the sound signal or the capacitance change.

2. The rain sensor of claim 1, wherein the first sensor includes a Micro Electro-Mechanical Systems (MEMS) microphone.

3. The rain sensor of claim 1, wherein the second sensor is a capacitive sensor and includes a first capacitor and a second capacitor.

4. The rain sensor of claim 3, wherein the first capacitor includes a pair of transparent electrodes spaced apart from each other by a first gap, and
wherein the second capacitor includes a pair of transparent electrodes spaced apart from each other by a second gap different from the first gap.

5. The rain sensor of claim 4, wherein the first capacitor detects a raindrop of a first size or larger, and
wherein the second capacitor detects a raindrop of a second size or smaller.

6. The rain sensor of claim 5, wherein the first capacitor and the second capacitor detect a raindrop of more than the first size and less than the second size together.

7. The rain sensor of claim 3, wherein the second surface of the substrate is attached to the windshield glass of the vehicle with a thermal curable polymer adhesive.

8. The rain sensor of claim 1, wherein the processor determines whether the sound signal corresponds to a sound of rain, by analyzing strength and frequency characteristics of the sound signal.

9. The rain sensor of claim 8, wherein the processor determines a rainfall step by estimating a size, an amount, and a speed of a raindrop by analyzing the strength and the frequency characteristics of the sound signal.

10. The rain sensor of claim 1, wherein the processor determines a rainfall step by estimating a size, an amount, and a speed of a raindrop by analyzing the capacitance change.

11. The rain sensor of claim 9, wherein the processor transmits a rainfall step determination result to a wiper controller to control a movement of a wiper.

12. A wiper system comprising:
the rain sensor set forth in claim 1; and
a wiper controller configured to control a movement of a wiper, based on rainfall information measured by the rain sensor.

13. A method for controlling a wiper using the rain sensor set forth in claim 1, the method comprising:
detecting at least one of the sound signal through the first sensor or the capacitance change through the second sensor;
determining, by the rain sensor, a rainfall step based on at least one of the sound signal or the detected capacitance change; and
controlling, by a wiper controller, a movement of the wiper according to the rainfall step.

14. The method of claim 13, wherein the detecting at least one of the sound signal or the change in capacitance includes:
detecting, by the rain sensor, the sound signal through the first sensor;
determining, by the rain sensor, whether the sound signal corresponds to a sound of rain, by analyzing strength and frequency characteristics of the sound signal; and
detecting, by the rain sensor, the capacitance change through the second sensor when the sound signal does not correspond to the sound of rain.

15. The method of claim 14, wherein the determining a rainfall step includes:
determining the rainfall step by estimating a size, an amount, and a speed of a raindrop by analyzing the strength and the frequency characteristics of the sound signal when the sound signal corresponds to the sound of rain.

16. The method of claim 14, wherein the determining a rainfall step includes:
determining whether the capacitance is increased; and
determining the rainfall step by estimating a size, an amount, and a speed of a raindrop by analyzing the capacitance change when the capacitance is increased.

17. The method of claim 16, wherein the determining a rainfall step further includes:
standing by for a preset period of time when the capacitance is not increased, after the determining whether the capacitance is increased.

18. The method of claim 13, wherein the controlling a movement of the wiper includes:
adjusting, by the wiper controller, at least one of an operating speed or an operating interval of the wiper.

19. The method of claim 18, wherein the wiper controller operates the wiper to remove foreign matter when there is no change in capacitance measured by the second sensor in the rain sensor.

20. The rain sensor of claim 10, wherein the processor transmits a rainfall step determination result to a wiper controller to control a movement of a wiper
